(19) United States
(12) Patent Application Publication
(10) Pub. No.: US 2011/0304773 A1
(43) Pub. Date: Dec. 15, 2011

(54) IMAGE PROCESSING APPARATUS AND IMAGE PROCESSING METHOD

(76) Inventor: Akihiro Okumura, Kanagawa (JP)

(21) Appl. No.: 13/153,023

(22) Filed: Jun. 3, 2011

(30) Foreign Application Priority Data
Jun. 11, 2010 (JP) P2010-133559

(51) Int. Cl. G06K 9/40; H04N 5/21

(52) U.S. Cl. 348/607; 382/260; 348/E05.001

(57) ABSTRACT

An image processing apparatus includes: n input receiving means for receiving input image signals representing images to be displayed as video images on n divided screens obtained by dividing a screen of a display into n areas having the same number of pixels; n accumulative weighted averaging means for identifying pixels to be processed having the same relative positions in one-frame-length images displayed on the n divided screens corresponding to the image signals inputted through the n input receiving means and accumulatively performing weighted averaging on the pixels to be processed whenever the frame changes; n memories that store the pixels of the one-frame-length images displayed on the n divided screens and having undergone the accumulative weighted averaging; and access switching means for switching the memories accessed by the n accumulative weighted averaging means based on a control signal outputted from one of the n accumulative weighted averaging means.

### FIELD

The present disclosure relates to an image processing apparatus and an image processing method, and particularly to an image processing apparatus and an image processing method for displaying pixels located in the vicinity of the boundary between divided screens with the amount noise appropriately reduced.

### BACKGROUND

A video signal representing video images contains similar image information repeated on a frame basis, and adjacent frames very strongly correlate with each other. On the other hand, since a video signal does not correlate with coding distortion or noise components, averaging a video signal on a frame basis along the temporal axis affects a signal component little but reduces only the amounts of distortion and noise components, whereby the amounts of distortion and noise can be reduced. As a noise reduction apparatus using the characteristic of a video signal described above, a motion detection, frame circulating type noise reduction apparatus has been proposed (see JP-A-2004-88234, for example).

The noise reduction apparatus of the related art detects a motion vector, determines a motion component based on the motion vector, changes a circulating coefficient in accordance with the motion component in images, and performs weighted averaging on pixels in the current frame and the corresponding pixels in the preceding frame based on the circulating coefficient to produce an output video signal. In the configuration described above, the weighted averaging is accumulatively performed on the corresponding pixels having undergone the motion compensation, whereby the amount of noise can be reduced with no afterimages produced.

In recent years, trends in digital cinemas, home theaters, and next-generation TVs and other circumstances have encouraged manufacturers to introduce displays having a resolution of 4K×2K or higher. For example, screen division and other techniques that enable higher definition images than ever are typically required. To provide such an advanced system using a motion detection, frame circulating type noise reduction apparatus of related art, a filter LSI and a memory are used.

### SUMMARY

When screen division is performed by using a method of related art, for example, when a panned image is divided into multiple screens, a result obtained in a process associated with a predetermined divided screen is necessary to display another divided screen. A hardware configuration of relate art typically cannot transfer a result obtained in a process associated with a predetermined divided screen to another divided screen, resulting in degradation in image quality in some cases.

Thus, it is desirable to display pixels located in the vicinity of the boundary between divided screens with the amount of noise appropriately reduced.

An embodiment of the present disclosure is directed to an image processing apparatus including: n input receiving means for receiving input image signals representing images to be displayed as video images on n divided screens obtained by dividing a screen of a display into n areas having the same number of pixels, n accumulative weighted averaging means for identifying pixels to be processed having the same relative positions in one-frame-length images displayed on the n divided screens corresponding to the image signals inputted through the n input receiving means and accumulatively performing weighted averaging on the pixels to be processed whenever the frame changes, n memories that store the pixels of the one-frame-length images displayed on the n divided screens and having undergone the accumulative weighted averaging, and access switching means for switching the memories accessed by then accumulative weighted averaging means based on a control signal outputted from one of the n accumulative weighted averaging means.

Each of the accumulative weighted averaging means may extract a block that is to be processed and formed of the pixel to be processed and a plurality of pixels therearound, read pixels in an image of a frame immediately before the frame containing the pixel to be processed from the corresponding one of the memories, the pixels contained in a predetermined area around a pixel having the same coordinates as the pixel to be processed, extract based on the pixels read from the memory a plurality of comparison blocks each of which is formed of the same number of pixels as the block to be processed, identify a pixel corresponding to the pixel to be processed in the image of the immediately preceding frame based on the similarities between the block to be processed and the comparison blocks, and perform weighted averaging based on a circulating coefficient on the value of the pixel to be processed and the value of the pixel corresponding to the pixel to be processed in the image of the immediately preceding frame.

When pixels of the image displayed on a divided screen different from the divided screen that displays the image containing the pixel to be processed are read as the pixels used in the comparison blocks, at least one of the accumulative weighted averaging means may output a control signal for identifying a memory that stores the pixels displayed on the different divided screen.

When the pixel to be processed is located within a predetermined distance from a boundary corresponding to a side of the rectangular divided screen that displays the pixel to be processed, pixels of the image displayed on a divided screen different from the divided screen that displays the image containing the pixel to be processed may be read as the pixels used in the comparison blocks, and the control signal may be outputted in the form of coordinates representing a position on the different divided screen adjacent to the boundary.

When no divided screen adjacent to the boundary is present, the access switching means may supply dummy data to the accumulative weighted averaging means.

Each of the accumulative weighted averaging means may be configured in the form of LSI.

The embodiment of the present disclosure is also directed to an image processing method including: receiving input image signals through n input receiving means, the input image signals representing images to be displayed as video images on n divided screens obtained by dividing a screen of a display into n areas having the same number of pixels, identifying pixels to be processed having the same relative positions in one-frame-length images displayed on the n divided screens corresponding to the image signals inputted through the n input receiving means and accumulatively performing weighted averaging on the pixels to be processed whenever the frame changes, the pixels to be processed identified and the weighted averaging performed by n accumulative weighted averaging means, and storing in n memories the pixels of the one-frame-length images displayed on the n divided screens and having undergone the accumulative weighted averaging, and the memories accessed by the n accumulative weighted averaging means are switched based on a control signal outputted from one of the n accumulative weighted averaging means.

In the embodiment of the present disclosure, input image signals representing images to be displayed as video images on n divided screens obtained by dividing a screen of a display into n areas having the same number of pixels are received. Pixels to be processed having the same relative positions in one-frame-length images displayed on the n divided screens corresponding to the input image signals are identified, and weighted averaging are accumulatively performed on the pixels to be processed whenever the frame changes. The pixels of the one-frame-length images displayed on the n divided screens and having undergone the accumulative weighted averaging are stored in n memories. The memories accessed by the n accumulative weighted averaging means are switched based on a control signal outputted from one of the n accumulative weighted averaging means.

Another embodiment of the present disclosure is directed to an image processing apparatus including: n input receiving means for receiving input image signals representing images to be displayed as video images on n divided screens obtained by dividing a screen of a display into n areas having the same number of pixels, n accumulative summing means for identifying pixels to be processed having the same relative positions in one-frame-length images displayed on the n divided screens corresponding to the image signals inputted through the n input receiving means and accumulatively summing characteristic values of the pixels to be processed whenever the frame changes, n memories that store the characteristic values of the pixels of the one-frame-length images displayed on the n divided screens and having undergone the accumulative summing, and access switching means for switching the memories accessed by the n accumulative summing means based on a control signal outputted from one of the n accumulative summing means.

In this embodiment of the present disclosure, input image signals representing images to be displayed as video images on n divided screens obtained by dividing a screen of a display into n areas having the same number of pixels are received. Pixels to be processed having the same relative positions in one-frame-length images displayed on the n divided screens corresponding to the input image signals are identified, and characteristic values of the pixels to be processed are accumulatively summed whenever the frame changes. The characteristic values of the pixels of the one-frame-length images displayed on the n divided screens and having undergone the accumulative summing are stored in n memories. The memories accessed by the n accumulative summing means are switched based on a control signal outputted from one of the n accumulative summing means.

According to the embodiments of the present disclosure, pixels located in the vicinity of the boundary between divided screens can be displayed with the amount of noise appropriately reduced.

### BRIEF DESCRIPTION OF THE DRAWINGS

FIG. 1 is a block diagram showing an example of the configuration of an IIR filter;

FIG. 2 is a block diagram showing an example of the configuration of an IIR filter configured in the form of LSI;

FIG. 3 shows an example in which a screen that displays an image of a resolution of 4K×2K is divided into divided screens 1 to 4;

FIG. 4 is a block diagram showing an example of the configuration of a parallel noise reduction apparatus of related art;

FIG. 5 describes a problem that occurs when the screen of a display is divided into four and noise reduction is performed on each of the divided screens;

FIG. 6 is a block diagram showing an example of the configuration of a parallel noise reduction apparatus according to an embodiment of the present disclosure;

FIG. 7 is a block diagram showing an example of the configuration commonly employed by IIR filter LSIs shown in FIG. 6;

FIG. 8 describes an extended address control signal;

FIG. 9 is a flowchart for describing noise reduction;

FIG. 10 shows another example in which a screen that displays an image of a resolution of 4K×2K is divided into divided screens 1 to 4; and

FIG. 11 shows still another example in which a screen that displays an image of a resolution of 4K×2K is divided into divided screens 1 to 4.

### DETAILED DESCRIPTION

Embodiments of the present disclosure will be described below with reference to the drawings.

A frame circulating type noise reduction apparatus of related art will first be described. For example, a video signal (image signal) representing video images contains similar image information repeated on a frame basis, and adjacent frames very strongly correlate with each other. On the other hand, since a video signal does not correlate with coding distortion or noise components, averaging a video signal on a frame basis along the temporal axis affects a signal component little but reduces only the amounts of distortion and noise components, whereby the amounts of distortion and noise can be reduced. A frame circulating type noise reduction apparatus, which is also referred to as an IIR (infinite impulse response) filter, is an apparatus that uses the characteristic of an image signal described above to reduce the amount of noise.

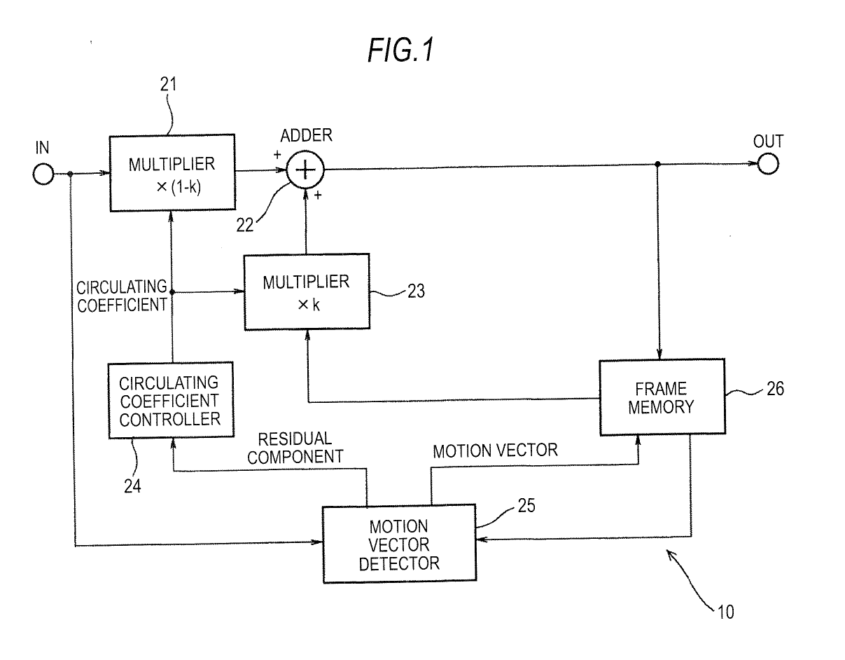

FIG. 1 is a block diagram showing an example of the configuration of an IIR filter. In FIG. 1, an IIR filter 10 includes a multiplier 21, an adder 22, a multiplier 23, a circulating coefficient controller 24, a motion vector detector 25, and a frame memory 26.

The IIR filter 10 is configured to reduce the amount of noise by accumulatively performing weighted averaging on the pixel value of each pixel contained in an inputted image signal.

The image signal inputted to the IIR filter 10 in the form of digital signal is supplied to the multiplier 21 in the form of data on a pixel basis and multiplied by a coefficient expressed by (1−K). The coefficient K is a circulating coefficient and satisfies 0≦K≦1. The circulating coefficient controller 24 determines the value of the circulating coefficient K, as will be described later.

The pixel value data having undergone the process carried out by the multiplier 21 is supplied to the adder 22, which adds the supplied data to the pixel value data having undergone a process carried out by the multiplier 23.

The multiplier 23 is configured to multiply pixel value data outputted from the frame memory 26 by the circulating coefficient K.

The frame memory 26 stores pixel value data contained in an image signal representing an image of the immediately preceding frame and having undergone the processes carried out by the multiplier 21 and the adder 22. That is, the frame memory stores data on the immediately preceding frame to be outputted from the IIR filter 10.

The frame memory 26 is configured to read the pixel value data on a pixel having coordinates identified by a motion vector detected by the motion vector detector 25 and supply the read pixel value data to the multiplier 23.

The motion vector detector 25 computes the sum of absolute values of difference, for example, between a block formed of a pixel to be processed and a plurality of pixels therearound contained in an inputted image signal corresponding to one frame and a block formed of a plurality of pixels contained in an image signal representing an image of the immediately preceding frame and stored in the frame memory 26. That is, the motion vector detector 25 is configured to perform, for example, what is called block matching.

In block matching, the sum of absolute values of difference between a block containing a pixel of interest (pixel to be processed) and each of a plurality of blocks each of which is formed of a plurality of pixels contained in an image of the immediately preceding frame is computed, and the block showing the smallest sum of absolute difference values is assigned as the most similar block. For example, a predetermined search area is so set in the image of the immediately preceding frame that the center of the search area is a pixel having the same coordinates as the pixel of interest, and pixels in the search area are used to extract a plurality of blocks each of which is formed of the same number of pixels as the block containing the pixel of interest.

The motion vector detector 25 identifies a motion vector associated with the pixel being processed by identifying a block most similar to the block containing the pixel being processed, for example, by performing block matching. When the motion vector is identified as described above, the coordinates of a pixel contained in the immediately preceding frame and corresponding to the pixel being currently processed by the multiplier 21 (pixel being processed) are identified.

In this way, the frame memory 26 reads the pixel value data on the pixel contained in the immediately preceding frame and corresponding to the pixel being processed and supplies the read pixel value data to the multiplier 23.

The adder 22 then adds the value obtained by multiplying the pixel value data on the pixel being processed by (1−K) to the value obtained by multiplying the pixel value data on the pixel in the immediately preceding frame by K, as described above. Weighted averaging is thus performed on the pixel value of the pixel being processed based on the pixel value of the corresponding pixel in the immediately preceding frame and the circulating coefficient K.

The circulating coefficient controller 24 is configured to determine the circulating coefficient K based on the accuracy of the motion vector. The motion vector detector 25 is configured to output a residual component representing the smallest sum of absolute difference values between the blocks obtained in the block matching. The accuracy of the motion vector is higher when the residual component has a smaller value.

When the motion vector is accurate (when the residual component has a small value), the corresponding pixel in the immediately preceding frame has probably been accurately identified. In this case, the circulating coefficient controller 24 increases the circulating coefficient K. As a result, the weighted averaging is so performed that the pixel value of the corresponding pixel in the immediately preceding frame has an increased weight.

When the motion vector is not very accurate (when the residual component has a large value), the corresponding pixel in the immediately preceding frame has probably not been accurately identified. In this case, the circulating coefficient controller 24 lowers the circulating coefficient K. As a result, the weighted averaging is so performed that the pixel value of the pixel being processed has an increased weight.

As described above, in the noise reduction performed by the IIR filter, weighted averaging is accumulatively performed on the pixel value of each pixel contained in an inputted image signal. That is, weighted averaging is performed on the pixel value of a pixel to be processed by using the pixel value of a pixel in an image of the frame immediately before the image containing the pixel to be processed, and the pixel value of the pixel on which the weighted averaging has been performed is stored in the frame memory 26. When an image signal representing the next frame is inputted, the pixel value stored in the frame memory 26 is read as the pixel value of the pixel corresponding to a pixel to be processed in the next frame. The weighted averaging is thus accumulatively performed on a pixel value on a frame basis.

The above example has been described with reference to the case where motion compensation is performed by using the motion vector detector 25 to identify a motion vector and weighted averaging is accumulatively performed on the pixel value of each pixel. Alternatively, the motion compensation may not be performed. That is, irrespective of motion in images, a pixel having the same coordinates as the pixel to be processed may be identified as the corresponding pixel in the immediately preceding frame.

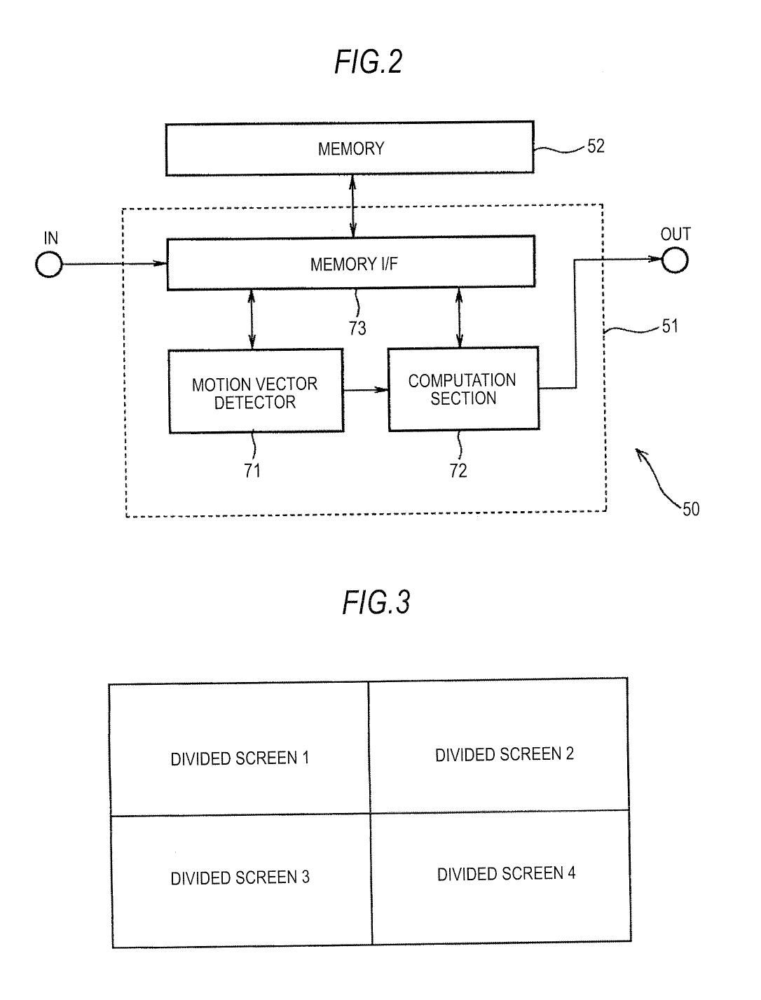

The IIR filter shown in FIG. 1 can be configured in the form of LSI. FIG. 2 is a block diagram showing an example of the configuration of an IIR filter configured in the form of LSI. In the example, an IIR filter 50 is formed of an LSI 51 and a memory 52. An image signal is inputted through a terminal IN of the IIR filter 50, and the image signal having undergone noise reduction is outputted through a terminal OUT of the IIR filter 50.

The memory 52 shown in FIG. 2 corresponds to the frame memory 26 shown in FIG. 1. That is, the memory 52 is provided external to the LSI 51 because when a circuit is configured in the form of LSI in general, no memory can be formed as part of the LSI.

The LSI 51 has a memory I/F (interface) 73 because the memory 52 is provided external to the LSI 51. In the example shown in FIG. 2, the terminal IN is connected to the memory I/F 73. The memory I/F 73 is configured to have a built-in buffer that can hold, for example, the pixel value data on pixels used in block matching performed by a motion vector detector 71.

The motion vector detector 71 shown in FIG. 2 corresponds to the motion vector detector 25 shown in FIG. 1, and a computation section 72 is a functional block that carries out the processes corresponding to the processes from the multiplier 21 to the circulating coefficient controller 24 shown in FIG. 1. In the example shown in FIG. 2, the terminal OUT is connected to the computation section 72.

In recent years, displays having a resolution of 4K×2K (or higher) have been developed in the field of digital cinemas, home theaters, and other similar apparatus. The resolution of 4K×2K means that the number of pixels arranged in the horizontal direction of a screen is 4K (4096) and the number of pixels arranged in the vertical direction of the screen is 2K (2048).

In a display of this type, it is also necessary to reduce the amount of noise. To this end, it is conceivable to use the IIR filter described with reference to FIG. 1 that reduces the amount of noise. An IIR filter is, however, typically provided in the form of LSI in many cases, and the processing capacity of such an IIR filter can reduce only the amount of noise associated with an image having a resolution of approximately 2K×1K (2K pixels in the horizontal direction and 1K pixels in the vertical direction) at the maximum.

An IIR filter capable of processing an image of a resolution of 4K×2K, if such an IIR filter can be newly developed, will be very expensive, because the resolution of 4K×2K has pixels to be processed per frame approximately four times greater than the resolution of 2K×1K, and a circuit board or an LSI operable at a very high clock rate is necessary in this case.

To perform noise reduction on an image of a resolution of 4K×2K, it has been proposed that a screen is divided into four, for example, as shown in FIG. 3 and noise reduction is performed on each of the four divided screens. In the example shown in FIG. 3, a screen that displays an image of a resolution of 4K×2K is divided into divided screens 1 to 4.

Since each of the divided screens 1 to 4 shown in FIG. 3 displays an image having the same number of pixels as an image of a resolution of 2K×1K, a typical IIR filter in the form of LSI can be used to reduce the amount of noise. That is, a single screen is divided into four areas, and noise reduction is independently performed in parallel on each of the areas.

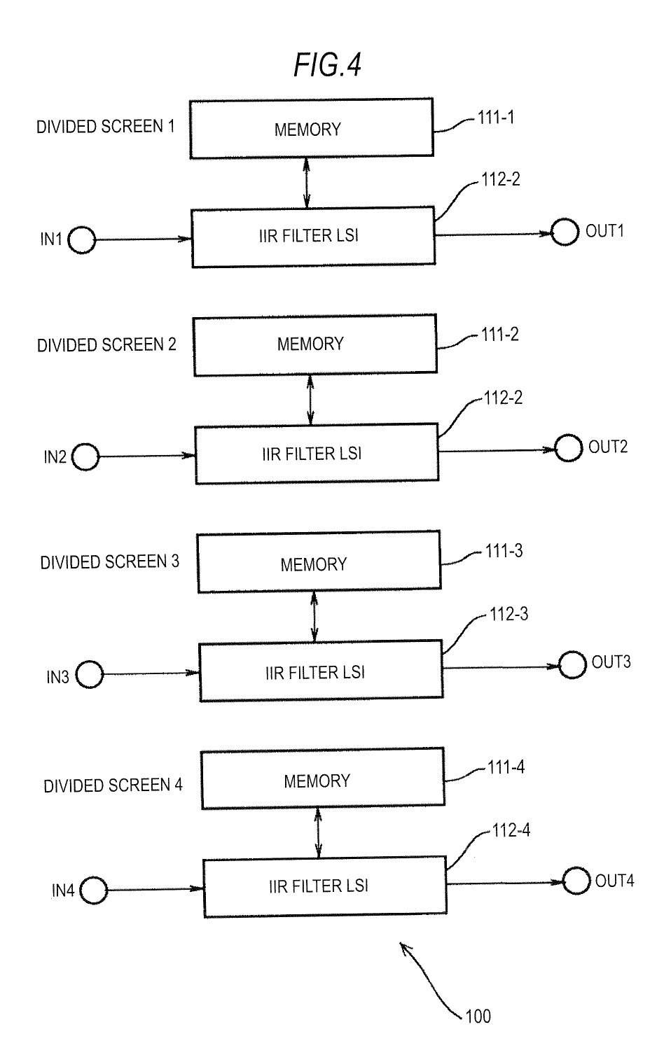

FIG. 4 is a block diagram showing an example of the configuration of a parallel noise reduction apparatus 100 of related art that processes in parallel, for example, the four divided screens shown in FIG. 3.

In the example shown in FIG. 4, an image signal representing the divided screen 1 shown in FIG. 3 is inputted through a terminal IN1, and weighted averaging is accumulatively performed on the pixel value of each pixel for noise reduction. The image signal representing the divided screen 1 on which the noise reduction has been performed is outputted through a terminal OUT1 and displayed as an image of the divided screen 1 of a display capable of displaying an image of a resolution of 4K×2K.

Further, an image signal representing the divided screen 2 shown in FIG. 3 is inputted through a terminal IN2, and weighted averaging is accumulatively performed for noise reduction on the pixel value of the pixel in the position corresponding to the position of the pixel described above in the divided screen 1. The image signal representing the divided screen 2 on which the noise reduction has been performed is outputted through a terminal OUT2 in synchronization with the image signal representing the divided screen 1 and displayed as an image of the divided screen 2 of the display capable of displaying an image of a resolution of 4K×2K.

Similarly, image signals representing the divided screens 3 and 4 shown in FIG. 3 are inputted through terminals IN3 and IN4, and weighted averaging is accumulatively performed for noise reduction on the pixel values of the pixels in the positions corresponding to the position of the pixel described above in the divided screen 1. The image signals representing the divided screens 3 and 4 on which the noise reduction has been performed are outputted through terminals OUT3 and OUT4 in synchronization with the image signal representing the divided screen 1 and displayed as images of the divided screens 3 and 4 of the display capable of displaying an image of a resolution of 4K×2K.

As described above, since all the image signals inputted through the terminals IN1 to IN4 contain the same number of pixels (the number of pixels corresponding to the resolution of 2K×1K), each pixel is processed in synchronization with the other corresponding pixels. As a result, the screen having a resolution of 4K×2K and formed of the divided screens 1 to 4 is displayed as a single screen at a predetermined frame rate on the display.

The image signals inputted through the terminals IN1 to IN4 are processed by using an IIR filter LSI 112-1 and a memory 111-1 to an IIR filter LSI 112-4 and a memory 111-4, respectively.

Each of the IIR filter LSI 112-1 and the memory 111-1 to the IIR filter LSI 112-4 and the memory 111-4 has the same configuration as that described above with reference to FIG. 2. That is, each of the IIR filter LSIs 112-1 to 112-4 has the same configuration as that of the LSI 51 shown in FIG. 2, and each of the memories 111-1 to 111-4 has the same configuration as that of the memory 52 shown in FIG. 2, which practically means that the combination of each of the IIR filter LSIs and the corresponding memory forms a single IIR filter.

The parallel noise reduction apparatus 100 thus performs independent noise reduction in parallel on each of the four areas obtained by dividing a single screen. Noise reduction can therefore be performed on an image of a resolution of 4K×2K without a circuit board or an LSI operable at a very high clock rate.

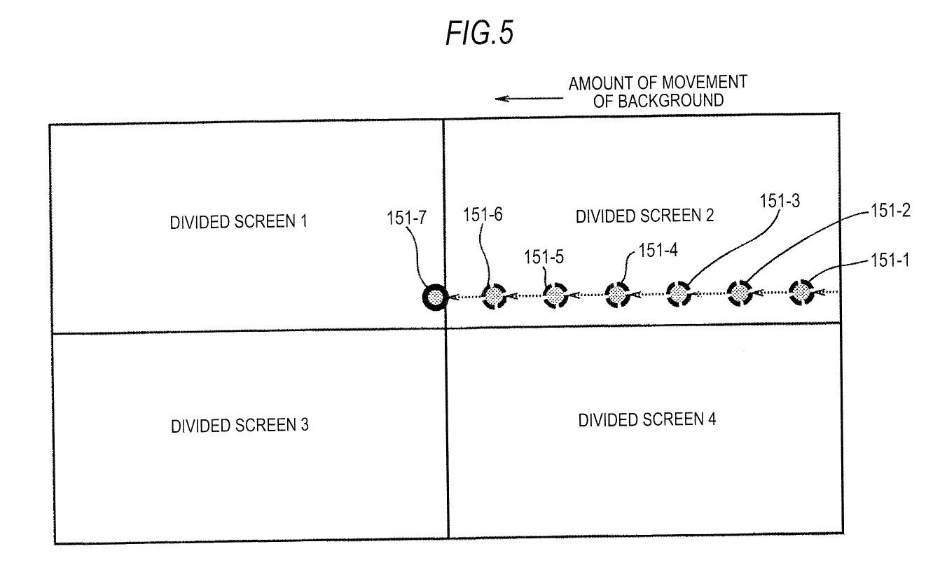

When the parallel noise reduction apparatus 100 shown in FIG. 4 is used, however, there is a problem described below with reference to FIG. 5.

FIG. 5 describes the problem that occurs when the screen of a display is divided into four and noise reduction is performed on each of the divided screens. In FIG. 5, the screen that displays an image of a resolution of 4K×2K is divided into divided screens 1 to 4, as in FIG. 3.

A circular object is displayed on the divided screen 2 shown in FIG. 5. The object moves from right to left on the screen in FIG. 5 with time and is first displayed as an object 151-1. As the time elapses, the object is sequentially displayed as objects 151-2 to 151-6. As the time further elapses, the object moves into the area where the divided screen 1 is displayed and is displayed as an object 151-7.

The object 151-6, which was displayed on the divided screen 2, and the object 151-7, which is displayed on the divided screen 1, are originally the same object, but they undergo the noise reduction separately. That is, it is necessary in the IIR filter-based noise reduction to accumulatively perform weighted averaging on the pixel value of each pixel, but the pixel corresponding to the object 151-7 is the pixel where the object 151-6 was displayed on the divided screen 2, and no weighted averaging can be accumulatively performed on the pixel values associated with the object.

For example, when the parallel noise reduction apparatus 100 shown in FIG. 4 is used, the search area defined in the block matching performed by the motion vector detector 71 in the IIR filter LSI 112-1 can contain no pixel in the divided screen 2, because the pixel value of the pixel where the object 151-6 was displayed having undergone accumulative weighted averaging is stored in the memory 111-2. That is, since the IIR filter LSI 112-1, which performs noise reduction on the pixel where the object 151-7 is displayed on the divided screen 1, is not allowed to access the memory 111-2, no weighted averaging can be accumulatively performed on the pixel value of the pixel where the object 151-7 is displayed.

As described above, when the parallel noise reduction apparatus 100 shown in FIG. 4 is used to perform noise reduction on the screen shown in FIG. 5, the objects 151-1 to 151-6 are displayed with a reduced amount of noise, whereas the object 151-7 is displayed with an unchanged amount of noise.

That is, the parallel noise reduction apparatus of related art typically cannot display pixels in the vicinity of the boundary between divided screens with the amount of noise appropriately reduced. As a result, the displayed image looks strange. In particular, since the boundaries between the four divided screens meet at the center of the screen shown in FIG. 5, where a user who is viewing the display pays the greatest attention, the image of the central portion looks strange.

In view of the circumstances described above, the present disclosure provides a parallel noise reduction apparatus capable of displaying pixels in the vicinity of the boundary between divided screens with the amount of noise appropriately reduced.

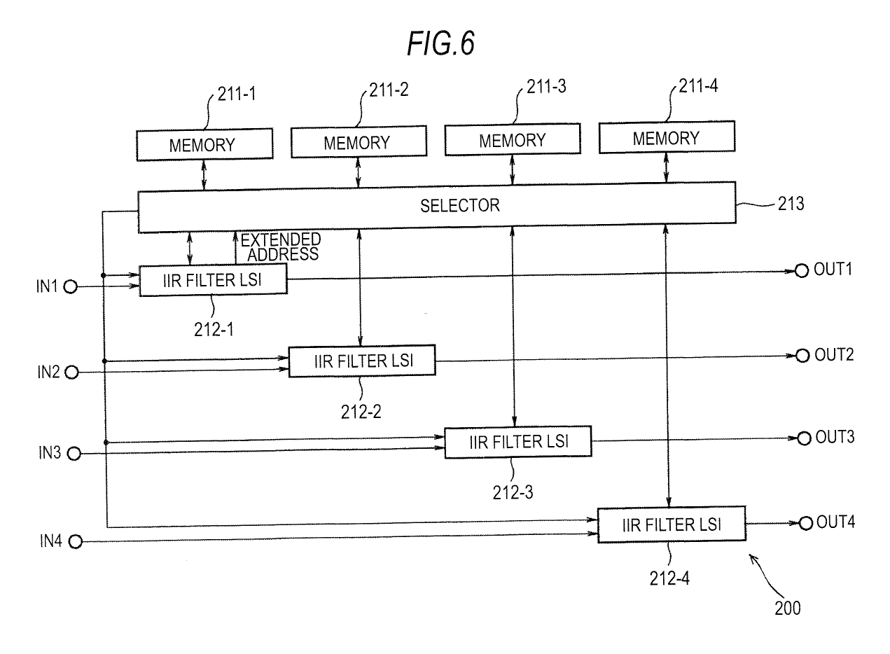

FIG. 6 is a block diagram showing an example of the configuration of a parallel noise reduction apparatus 200 according to an embodiment of the present disclosure. The parallel noise reduction apparatus 200 shown in FIG. 6 processes four divided screens in parallel, as in FIG. 4.

That is, an image signal representing the divided screen 1 shown in FIG. 3 is inputted through a terminal IN1, and weighted averaging is accumulatively performed on the pixel value of each pixel for noise reduction. The image signal representing the divided screen 1 on which the noise reduction has been performed is outputted through a terminal OUT1 and displayed as an image of the divided screen 1 of a display capable of displaying an image of a resolution of 4K×2K.

Further, an image signal representing the divided screen 2 shown in FIG. 3 is inputted through a terminal IN2, and weighted averaging is accumulatively performed for noise reduction on the pixel value of the pixel in the position corresponding to the position of the pixel described above in the divided screen 1. The image signal representing the divided screen 2 on which the noise reduction has been performed is outputted through a terminal OUT2 in synchronization with the image signal representing the divided screen 1 and displayed as an image of the divided screen 2 of the display capable of displaying an image of a resolution of 4K×2K.

Similarly, image signals representing the divided screens 3 and 4 shown in FIG. 3 are inputted through terminals IN3 and IN4, and weighted averaging is accumulatively performed for noise reduction on the pixel values of the pixels in the positions corresponding to the position of the pixel described above in the divided screen 1. The image signals representing the divided screens 3 and 4 on which the noise reduction has been performed are outputted through terminals OUT3 and OUT4 in synchronization with the image signal representing the divided screen 1 and displayed as images of the divided screens 3 and 4 of the display capable of displaying an image of a resolution of 4K×2K.

As described above, since all the image signals inputted through the terminals IN1 to IN4 contain the same number of pixels (the number of pixels corresponding to the resolution of 2K×1K), each pixel is processed in synchronization with the other corresponding pixels. As a result, the screen having a resolution of 4K×2K and formed of the divided screens 1 to 4 is displayed as a single screen at a predetermined frame rate on the display.

The image signals inputted through the terminals IN1 to IN4 are supplied to IIR filter LSIs 212-1 to 212-4, respectively.

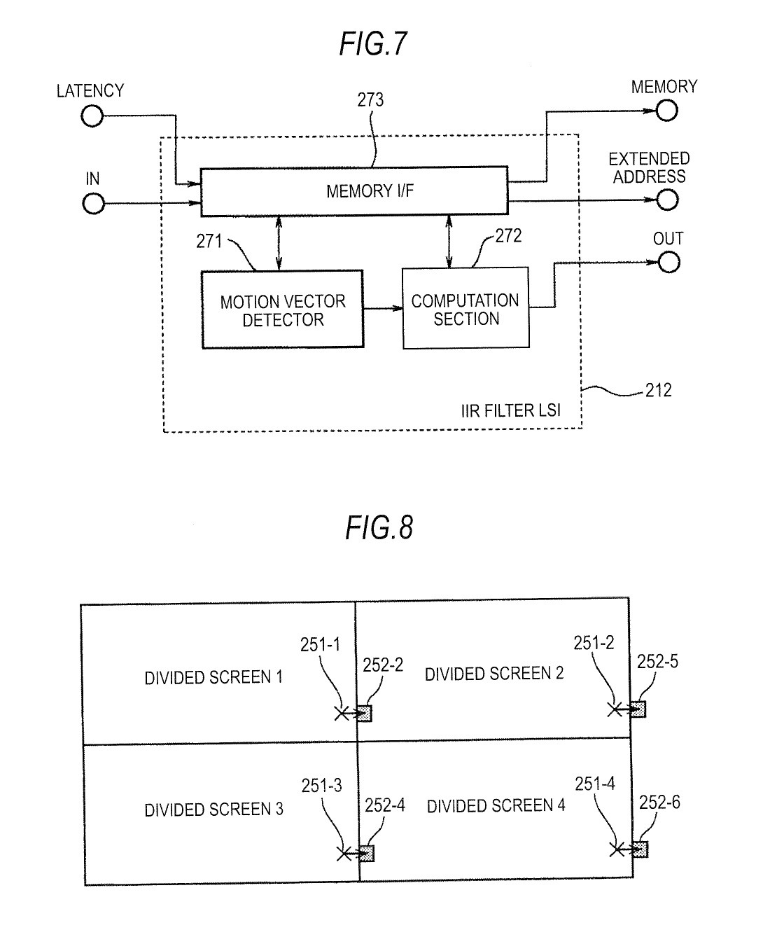

An example of the configuration of the IIR filter LSIs 212-1 to 212-4 will be described in detail with reference to FIG. 7.

FIG. 7 is a block diagram showing an example of the configuration commonly employed by the IIR filter LSIs 212-1 to 212-4 shown in FIG. 6. In FIG. 7, an IIR filter LSI 212 represents the IIR filter LSIs 212-1 to 212-4. An image signal is inputted through a terminal IN of the IIR filter LSI 212, and the image signal having undergone noise reduction is outputted through a terminal OUT of the IIR filter LSI 212.

In the example shown in FIG. 7, the IIR filter LSI 212 includes a motion vector detector 271, a computation section 272, and a memory I/F (interface) 273.

The motion vector detector 271 shown in FIG. 7 corresponds to the motion vector detector 25 shown in FIG. 1, and the computation section 272 is a functional block that carries out the processes corresponding to the processes form the multiplier 21 to the circulating coefficient controller 24 shown in FIG. 1. In the example shown in FIG. 7, the terminal OUT is connected to the computation section 272. That is, the motion vector detector 271 and the computation section 272 shown in FIG. 7 can be configured in the same manner as the motion vector detector 71 and the computation section 72 shown in FIG. 2.

In the example shown in FIG. 7, the terminal IN is connected to the memory I/F 273, as in the case of the memory I/F 73 shown in FIG. 2. Further, a terminal MEMORY, an extended address terminal, and a terminal LATENCY are connected to the memory I/F 273. The terminal MEMORY, the extended address terminal, and the terminal LATENCY are also connected to a selector 213 shown in FIG. 6.

The terminal MEMORY is an interface terminal for usual connection to a memory and also is a terminal for inputting and outputting, for example, a signal for identifying the address of a memory and a data signal written and read to and from the memory. The terminal MEMORY is, for example, formed of a signal line similar to the portion connecting the memory I/F 73 to the memory 52 shown in FIG. 2.

The extended address terminal is a terminal through which a control signal representing whether or not the address of readout data outputted through the terminal MEMORY is an extended address is outputted. The extended MEMORY is an address for reading a pixel in any of the other divided screens. The extended address will be described later in detail.

The terminal LATENCY is a terminal through which a control signal for adjusting a delay period typically required for a process performed by the selector 213 shown in FIG. 6 is inputted. When the IIR filter LSI 212 is designed in consideration of the delay period typically required for a process performed by the selector 213 shown in FIG. 6, the terminal LATENCY may be omitted.

The memory I/F 273 is configured to have a built-in buffer that can hold, for example, the pixel value data on pixels used in block matching performed by the motion vector detector 271.

Each of the IIR filter LSIs 212-1 to 212-4 shown in FIG. 6 is configured as described above. In FIG. 6, the combination of each of the IIR filter LSIs and the corresponding memory forms a single IIR filter.

The terminal MEMORY connected to the memory I/F 273 is also connected to the selector 213, as described above. Pixel value data contained in image signals outputted from the IIR filter LSIs 212-1 to 212-4 are therefore written into (stored in) memories 211-1 to 211-4 via the selector 213.

The pixel value data on the pixels of the image displayed on the divided screen 1 on which the noise reduction has been performed are stored in the memory 211-1, and the pixel value data on the pixels of the image displayed on the divided screen 2 on which the noise reduction has been performed are stored in the memory 211-2. Similarly, the pixel value data on the pixels of the image displayed on the divided screen 3 on which the noise reduction has been performed are stored in the memory 211-3, and the pixel value data on the pixels of the image displayed on the divided screen 4 on which the noise reduction has been performed are stored in the memory 211-4.

The pixel value data on the pixels of an image of the immediately preceding frame that are necessary in block matching performed by the motion vector detector 271 are also read from any of the memories 211-1 to 211-4 via the selector 213.

That is, in the parallel noise reduction apparatus 200 shown in FIG. 6, each of the IIR filter LSIs is configured to access the corresponding memory via the selector. The configuration allows, for example, the IIR filter LSI 212-1, when accumulatively performing weighted averaging on a pixel value, to read a pixel value data stored in the memory 211-2.

For example, when the IIR filter LSI 212-1 accesses the memory 211-2, a control signal outputted through the extended address terminal shown in FIG. 7 is used. The control signal, which represents, for example, a two-dimensional vector (kx, ky), notifies the selector 213 not only that a memory to be accessed is switched to another but also which memory should be accessed.

For example, let Xn be the number of divided screens in the horizontal (X-axis) direction of the original screen and Yn be the number of divided screens in the vertical (Y-axis) direction of the original screen. The control signal (kx, ky) outputted through the extended address terminal satisfies −(Xn−1)≦kx≦(Xn−1) and −(Yn−1)≦ky≦(Yn−1). In the present case, since the number of divided screens in the horizontal direction is two and the number of divided screens in the vertical direction is two, −1≦kx≦1 and −1≦ky≦1.

That is, for example, when the IIR filter LSI 212-1 accesses the memory 211-1, the control signal (kx, ky) outputted through the extended address terminal is set at (0, 0). On the other hand, when the IIR filter LSI 212-1 accesses the memory 211-2, the control signal (kx, ky) outputted through the extended address terminal is set at (1, 0).

Further, for example, when the IIR filter LSI 212-1 accesses the memory 211-3, the control signal (kx, ky) outputted through the extended address terminal is set at (0, 1). When the IIR filter LSI 212-1 accesses the memory 211-4, the control signal (kx, ky) outputted through the extended address terminal is set at (1, 1).

Further, for example, when the IIR filter LSI 212-4 accesses the memory 211-3, the control signal (kx, ky) outputted through the extended address terminal is set at (−1, 0). When the IIR filter LSI 212-4 accesses the memory 211-2, the control signal (kx, ky) outputted through the extended address terminal is set at (0, −1).

Further, for example, when the IIR filter LSI 212-3 accesses the memory 211-2, the control signal (kx, ky) outputted through the extended address terminal is set at (1, −1).

To read the pixel value data on pixels of an image displayed on a divided screen that displays an image containing a pixel to be processed, no control signal (kx, ky) may be outputted through the extended address terminal. For example, a control signal (0, 0) may not be outputted in the case described above, but control signals (−1, −1), (−1, 0), and so on may be outputted only when pixels of an image displayed on a divided screen different from a divided screen that displays an image containing a pixel to be processed.

As described above, the motion vector detector 271 shown in FIG. 7 corresponds to the motion vector detector 25 shown in FIG. 1, and the computation section 272 is a functional block that carries out the processes corresponding to the processes from the multiplier 21 to the circulating coefficient controller 24 shown in FIG. 1. The motion vector detector 25 shown in FIG. 1 computes the sum of absolute values of difference, for example, between a block formed of a pixel to be processed and a plurality of pixels therearound contained in an inputted image signal corresponding to one frame and a block formed of a plurality of pixels contained in an image signal representing the immediately preceding frame stored in the frame memory 26. That is, what is called block matching is performed.

When the motion vector detector 271 performs the block matching, it is necessary to acquire the pixel value data on the plurality of pixels around the pixel to be processed contained in the image signal corresponding to one frame from the corresponding one of the memories 211-1 to 211-4. For example, when a pixel in the vicinity of the boundary between divided screens is a pixel to be processed, it is necessary to read pixel value data necessary in the block matching described above from a memory where pixel value data for another divided screen is stored. To this end, in the embodiment of the present disclosure, the memory I/F 273 outputs not only an address signal for reading the pixel value data on a pixel at predetermined coordinates on the original screen through the terminal MEMORY but also a control signal through the extended address terminal as described above.

As described above, in the parallel noise reduction apparatus 200 according to the embodiment of the present disclosure, each of the IIR filter LSIs can specify an address beyond the address range of an accessible memory in related art. In other words, a control signal that enables control of such an extendable address (extended address) is outputted through the extended address terminal, as described above.

Among the extended address terminals of the IIR filter LSIs 212-1 to 212-4, only the extended address terminal of the IIR filter LSI 212-1 is connected to the selector 213, as shown in FIG. 6. The reason for this is that since each pixel is processed in synchronization with the corresponding other pixels as described above, a memory to be accessed may be switched to another based on an extended address control signal outputted from only one of the IIR filter LSIs 212-1 to 212-4.

All the extended address terminals of the IIR filter LSIs 212-1 to 212-4 may, of course, be connected to the selector 213, but the connection configuration shown in FIG. 7 allows decrease in the number of pins of the selector and simplification of circuit wiring.

For example, when the IIR filter LSI 212-1 processes a pixel 251-1 in the vicinity of the right boundary of the divided screen 1, it is necessary to perform block matching using pixels contained in an area 252-2 in an image of the immediately preceding frame displayed on the divided screen 2, as described in FIG. 8. That is, when a pixel of interest in the block matching is located in the vicinity of a boundary between divided screens, pixels on an adjacent screen are contained in a search area in the block matching.

In this case, a control signal (1, 0) is outputted through the extended address terminal. The control signal (1, 0) allows the selector 213 to switch the memory to be accessed to the relevant one, whereby the pixel value data on the pixels contained in the area 252-2 stored in the memory 211-2 can be read, and the read pixel value data can be supplied to the IIR filter LSI 212-1.

At this point, the IIR filter LSI 212-2 also processes a pixel 251-2 in the vicinity of the right boundary of the divided screen 2 because each pixel is processed in synchronization with the other corresponding pixels as described above.

When the IIR filter LSI 212-2 processes the pixel 251-2 in the vicinity of the right boundary of the divided screen 2, the block matching is performed by using the pixels contained in an area 252-5 in an image of the immediately preceding frame displayed on a virtual divided screen present on the right side of the divided screen 2 because the control signal (1, 0) has been outputted through the extended address terminal. Since no actual divided screen is present on the right side of the divided screen 2, dummy data is, for example, supplied as the pixel value data on the pixels contained in the area 252-5.

At this point, the IIR filter LSI 212-3 also processes a pixel 251-3 in the vicinity of the right boundary of the divided screen 3.

For example, when the IIR filter LSI 212-3 processes the pixel 251-3 in the vicinity of the right boundary of the divided screen 3, it is necessary to perform block matching using the pixels contained in an area 252-4 in an image of the immediately preceding frame displayed on the divided screen 4. In the present case, since the control signal (1, 0) has been outputted through the extended address terminal, the control signal (1, 0) allows the selector 213 to switch the memory to be accessed to the relevant one, whereby the pixel value data on the pixels contained in the area 252-4 stored in the memory 211-4 can be read, and the read pixel value data can be supplied to the IIR filter LSI 212-3.

At this point, the IIR filter LSI 212-4 also processes a pixel 251-4 in the vicinity of the right boundary of the divided screen 4.

Then the IIR filter LSI 212-4 processes the pixel 251-4 in the vicinity of the right boundary of the divided screen 4, the block matching is performed by using the pixels contained in an area 252-6 in an image of the immediately preceding frame displayed on a virtual divided screen present on the right side of the divided screen 4 because the control signal (1, 0) has been outputted through the extended address terminal. Since no actual divided screen is present on the right side of the divided screen 4, dummy data is, for example, supplied as the pixel value data on the pixels contained in the area 252-6.

Using the single selector 213 to switch a memory to be accessed as described above prevents a plurality of IIR filters from accessing the same memory. When a pixel in the vicinity of a boundary between divided screens is a pixel to be processed, noise reduction can still be performed by performing block matching using a search area containing pixels in the adjacent divided screen to identify a motion vector.

For example, when the pixel where the object 151-7 shown in FIG. 5 is displayed is the pixel to be processed and noise reduction is performed on that pixel, weighted averaging can be performed by using the pixel value data on the pixel where the object 151-6 corresponding to the immediately preceding frame was displayed on the divided screen 2, as in the same manner described above.

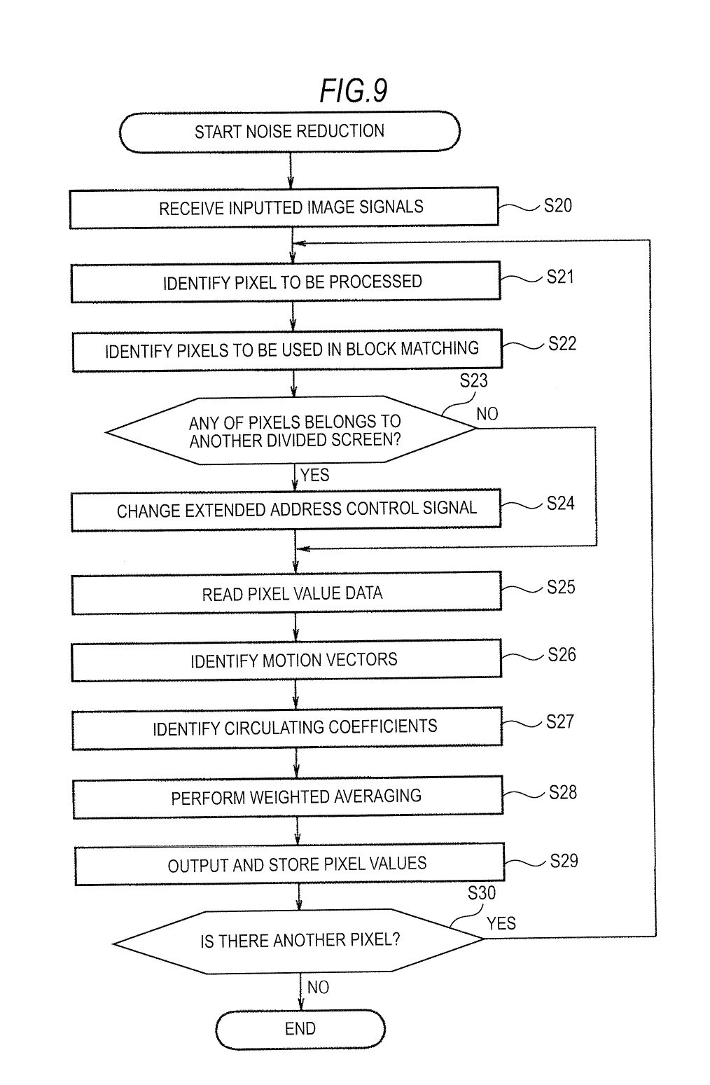

The noise reduction performed by the parallel noise reduction apparatus 200 shown in FIG. 6 will next be described with reference to the flowchart shown in FIG. 9.

In step S20, the parallel noise reduction apparatus 200 receives input image signals corresponding to images to be displayed on the divided screens 1 to 4.

In step S21, each of the IIR filter LSIs 212-1 to 212-4 identifies a pixel to be processed in the corresponding inputted image signal.

In step S22, each of the IIR filter LSIs 212-1 to 212-4 identifies pixels to be used in block matching for detecting a motion vector.

In step S23, each of the IIR filter LSIs 212-1 to 212-4 judges whether or not any of the pixels identified in the process in step S22 belongs to another divided screen. When the judgment in step S23 shows that any of the pixels identified in the process in step S22 belongs to another divided screen, the process in step S24 is carried out.

In step S24, the IIR filter LSI 212-1 changes the extended address control signal. The changed extended address control signal allows the selector 213 to switch the memories to be accessed by the IIR filter LSIs 212-1 to 212-4 to relevant ones.

On the other hand, when the judgment in step S23 shows that none of the pixels identified in the process in step S22 belongs to another divided screen, the process in step S24 is skipped.

In step S25, the IIR filter LSIs 212-1 to 212-4 read the pixel value data on the pixels identified in the process in step S22. When the pixels identified in the process in step S22 belong, for example, to the area 252-5 or 252-6 shown in FIG. 8, no actual data can be read. In this case, the selector 213 supplies, for example, dummy data. Each of the IIR filter LSIs 212-1 to 212-4 holds the thus read pixel value data in the buffer in the memory I/F 273.

In step S26, the IIR filter LSIs 212-1 to 212-4 identify motion vectors. In this process, the motion vectors are identified, for example, by performing block matching based on the pixel value data read in the process in step S25.

In step S27, the IIR filter LSIs 212-1 to 212-4 identify the circulating coefficients K. In this process, the circulating coefficients K are identified based, for example, on residual components produced in the block matching performed in the process in step S26.

In step S28, each of the IIR filter LSIs 212-1 to 212-4 performs weighted averaging on the pixel value data on the pixel to be processed and the pixel value data on the corresponding pixel in an image of the immediately preceding frame.

In this process, the corresponding pixel in the image of the immediately preceding frame is identified based, for example, on the motion vector obtained in the process in step S26, and the pixel value data on that pixel is read from the buffer in the memory I/F 273 in the corresponding one of the IIR filter LSIs 212-1 to 212-4. It is noted that the pixel value data on the corresponding pixel in the image of the immediately preceding frame has been read and stored in the process in step S25, specifically, has been read from the corresponding one of the memories 211-1 to 211-4 to be used in the block matching and has been stored in the buffer in the memory I/F 273 in the corresponding one of the IIR filter LSIs 212-1 to 212-4.

The pixel value of the pixel being processed, which has been identified in the process in step S21, is then multiplied by (1−K), and the pixel value data read from the buffer in the memory I/F 273 is multiplied by K. The pixel values having undergone the multiplication processes are added to each other. The pixel value of the pixel being processed and the pixel value of the corresponding pixel in the image of the immediately preceding frame thus undergo weighted averaging based on the circulating coefficient K obtained in the process in step S27.

In step S29, the IIR filter LSIs 212-1 to 212-4 output the results obtained in the process in step S28. In this way, the amounts of noise contained in the inputted image signals are reduced, and the image signals having undergone the noise reduction are outputted through the terminals OUT1 to OUT4. The outputted data on the processed results are written into (stored in) the memories 211-1 to 211-4 via the selector 213.

In step S30, the IIR filter LSIs 212-1 to 212-4 judge whether or not there is another pixel to be processed. When the judgment in step S30 shows that there is another pixel to be processed, the control returns to step S21, and the process in step S21 and the following processes are repeated.

When the judgment in step S30 shows that there is no pixel to be processed, the processes are terminated.

The noise reduction is thus performed.

In this way, weighted averaging can be accumulatively performed, for example, on the pixel value of the pixel corresponding to the object 151-7 displayed in the vicinity of the boundary between divided screens shown in FIG. 5. Pixels in the vicinity of the boundary between divided screens can therefore be displayed with the amount of noise appropriately reduced.

The above description has been made with reference to the case where a screen having a resolution of 4K×2K is divided into two in the horizontal and vertical directions. The screen may alternatively be divided in other ways.

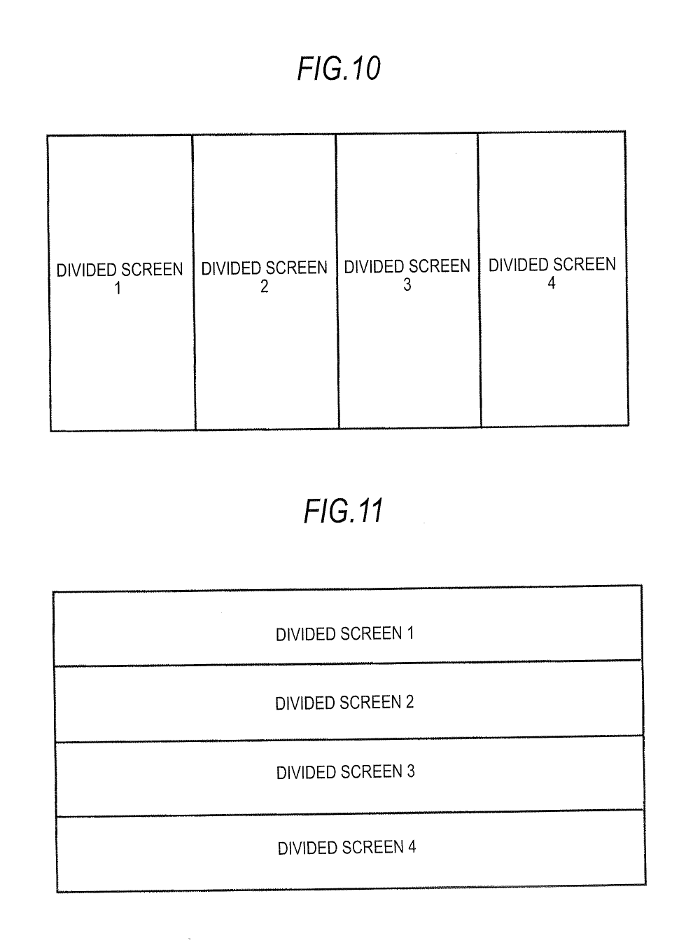

FIG. 10 shows another example of the division of a screen having a resolution of 4K×2K.

In the example shown in FIG. 10, a screen having a resolution of 4K×2K is divided into four in the horizontal direction. In this case, each of the divided screens 1 to 4 shown in FIG. 10 has a resolution of 1K×2K (1K in the horizontal direction and 2K in the vertical direction) or displays an image having the same number of pixels as each of the divided screens 1 to 4 shown in FIG. 3. Each of the divided screens 1 to 4 shown in FIG. 10 can therefore be processed by a single IIR filter LSI 212.

FIG. 11 shows still another example of the division of a screen having a resolution of 4K×2K.

In the example shown in FIG. 11, a screen having a resolution of 4K×2K is divided into four in vertical direction. In this case, each of the divided screens 1 to 4 shown in FIG. 11 has a resolution of 4K×0.5K (4K in the horizontal direction and 0.5K in the vertical direction) or displays an image having the same number of pixels as each of the divided screens 1 to 4 shown in FIG. 3. Each of the divided screens 1 to 4 shown in FIG. 11 can therefore be processed by a single IIR filter LSI 212.

The above description has been made with reference to the case where a high-resolution screen is divided into four low-resolution screens. Alternatively, a high-resolution screen may be divided, for example, into eight low-resolution screens or sixteen low-resolution screens.

Further, the above description has been made with reference to the case where the present disclosure is applied to the configuration in which weighted averaging is accumulatively performed on pixel values in images displayed on divided screens, but weighted averaging is not necessarily accumulatively performed on pixel values.

For example, the present disclosure may be applied as follows: The correlation between a pixel of interest in an image displayed on a divided screen and a corresponding pixel in an image displayed on the divided screen but corresponding to the immediately preceding frame is determined. It is judged whether or not the resultant correlation is continuously changed, and the number of continuously changed correlation values is counted. Any motion is then estimated based on the count on a pixel basis. That is, the present disclosure is applicable to a configuration in which a characteristic value of a pixel is accumulatively summed on a pixel basis.

The series of processes described above in the present specification include not only processes performed in time series in the described order but also processes performed not necessarily in time series but concurrently or individually.

Embodiments of the present disclosure are not limited to the embodiment described above, but a variety of changes can be made thereto to the extent that they do not depart from the substance of the present disclosure.

The present disclosure contains subject matter related to that disclosed in Japanese Priority Patent Application JP 2010-133559 filed in the Japan Patent Office on Jun. 11, 2010, the entire contents of which is hereby incorporated by reference.

What is claimed is:

1. An image processing apparatus comprising:
n input receiving means for receiving input image signals representing images to be displayed as video images on n divided screens obtained by dividing a screen of a display into n areas having the same number of pixels;
n accumulative weighted averaging means for identifying pixels to be processed having the same relative positions in one-frame-length images displayed on the n divided screens corresponding to the image signals inputted through the n input receiving means and accumulatively performing weighted averaging on the pixels to be processed whenever the frame changes;
n memories that store the pixels of the one-frame-length images displayed on the n divided screens and having undergone the accumulative weighted averaging; and
access switching means for switching the memories accessed by the n accumulative weighted averaging means based on a control signal outputted from one of the n accumulative weighted averaging means.

2. The image processing apparatus according to claim 1,
wherein each of the accumulative weighted averaging means
extracts a block that is to be processed and formed of the pixel to be processed and a plurality of pixels therearound,
reads pixels in an image of a frame immediately before the frame containing the pixel to be processed from the corresponding one of the memories, the pixels contained in a predetermined area around a pixel having the same coordinates as the pixel to be processed,
extracts based on the pixels read from the memory a plurality of comparison blocks each of which is formed of the same number of pixels as the block to be processed,
identifies a pixel corresponding to the pixel to be processed in the image of the immediately preceding frame based on the similarities between the block to be processed and the comparison blocks, and
performs weighted averaging based on a circulating coefficient on the value of the pixel to be processed and the value of the pixel corresponding to the pixel to be processed in the image of the immediately preceding frame.

3. The image processing apparatus according to claim 2,
wherein when pixels of the image displayed on a divided screen different from the divided screen that displays the image containing the pixel to be processed are read as the pixels used in the comparison blocks, at least one of the accumulative weighted averaging means outputs a control signal for identifying a memory that stores the pixels displayed on the different divided screen.

4. The image processing apparatus according to claim 3,
wherein when the pixel to be processed is located within a predetermined distance from a boundary corresponding to a side of the rectangular divided screen that displays the pixel to be processed, pixels of the image displayed on a divided screen different from the divided screen that displays the image containing the pixel to be processed are read as the pixels used in the comparison blocks, and
the control signal is outputted in the form of coordinates representing a position on the different divided screen adjacent to the boundary.

5. The image processing apparatus according to claim 4,
wherein when no divided screen adjacent to the boundary is present,
the access switching means supplies dummy data to the accumulative weighted averaging means.

6. The image processing apparatus according to claim 1,
wherein each of the accumulative weighted averaging means is configured in the form of LSI.

7. An image processing method comprising:
receiving input image signals through n input receiving means, the input image signals representing images to be displayed as video images on n divided screens obtained by dividing a screen of a display into n areas having the same number of pixels;
identifying pixels to be processed having the same relative positions in one-frame-length images displayed on the n divided screens corresponding to the image signals inputted through the n input receiving means and accumulatively performing weighted averaging on the pixels to be processed whenever the frame changes, the pixels to be processed identified and the weighted averaging performed by n accumulative weighted averaging means; and
storing in n memories the pixels of the one-frame-length images displayed on the n divided screens and having undergone the accumulative weighted averaging,
wherein the memories accessed by the n accumulative weighted averaging means are switched based on a control signal outputted from one of the n accumulative weighted averaging means.

8. An image processing apparatus comprising:
n input receiving means for receiving input image signals representing images to be displayed as video images on n divided screens obtained by dividing a screen of a display into n areas having the same number of pixels;
n accumulative summing means for identifying pixels to be processed having the same relative positions in one-frame-length images displayed on the n divided screens corresponding to the image signals inputted through the n input receiving means and accumulatively summing characteristic values of the pixels to be processed whenever the frame changes;
n memories that store the characteristic values of the pixels of the one-frame-length images displayed on the n divided screens and having undergone the accumulative summing; and
access switching means for switching the memories accessed by the n accumulative summing means based on a control signal outputted from one of the n accumulative summing means.
